(19) United States
(12) Patent Application Publication
(10) Pub. No.: US 2018/0275582 A1
(43) Pub. Date: Sep. 27, 2018

(54) IMAGE FORMING APPARATUS, REPLACEMENT MANAGEMENT SYSTEM FOR THE SAME, AND PROGRAM FOR IMAGE FORMING APPARATUS

(71) Applicant: KONICA MINOLTA, INC., Tokyo (JP)

(72) Inventors: Hideaki KOMIYAMA, Osaka (JP); Atsushi KAWAI, Toyokawa-shi (JP); Tatsutoshi YAMADA, Toyokawa-shi (JP); Hideo MAE, Kitanagoya-shi (JP)

(73) Assignee: KONICA MINOLTA, INC., Tokyo (JP)

(21) Appl. No.: 15/920,588

(22) Filed: Mar. 14, 2018

(30) Foreign Application Priority Data
Mar. 22, 2017 (JP) 2017-056025

(51) Int. Cl. G03G 15/00

(52) U.S. Cl. CPC G03G 15/553; G03G 15/75

(57) ABSTRACT

An image forming apparatus includes: a rotatable photosensitive member included in a photosensitive unit that is attachable and detachable; an exposing device that forms a latent image on a surface of the photosensitive member; a developing device that forms a toner image by providing toner onto the latent image by using two-component developer; an image stabilization control part that performs optimization of a parameter value of image formation while image formation is not performed; and a replacement determiner that makes determination of replacement of the photosensitive unit on a basis of an optimized value that is the parameter value optimized by the image stabilization control part, wherein the replacement determiner determines that the photosensitive unit should be replaced in a case where the optimized value corresponds to a photosensitive member replacement event that has been determined in advance.

The entire disclosure of Japanese patent Application No. 2017-056025, filed on Mar. 22, 2017, is incorporated herein by reference in its entirety.

### BACKGROUND

### Technological Field

The present invention relates to an image forming apparatus for forming an image by using toner. More specifically, the present invention relates to an image forming apparatus in which a photosensitive member is unitized as a replaceable unit. Further, the present invention is also applicable to a system for managing replacement of a photosensitive unit in such an image forming apparatus by a server, and a program for controlling the image forming apparatus.

### Description of the Related Art

Conventionally, in an image forming apparatus that forms an image by using toner, there is an apparatus in which a photosensitive member is made into a replaceable unit. Also, there is an apparatus in which a developing device is made into a replaceable unit separately from the unit of the photosensitive member. Among image forming apparatuses, in apparatuses using a two-component developer, in recent years, the lifetime of developing devices has remarkably elongated with the development of a trickle developing technique, and the lifetime of some of the developing devices is approaching the lifetime of the apparatus. For this reason, the replacement frequency of the photosensitive unit is higher than the replacement frequency of the developing unit. As management of the lifetime of the photosensitive member in this type of image forming apparatus, management based on the cumulative rotation time of the photosensitive member can be considered. This is because when the use time of the photosensitive member becomes long, the image carrying ability is lowered and sufficient image density cannot be obtained.

However, not only the deterioration state of the photosensitive member but also the deterioration state of the developing device affects the image quality. In particular, the image density tends to decrease due to the deterioration of the charging performance of the developer. For this reason, even though the lifetime of the developing device has been prolonged, management based only on the cumulative rotation time of the photosensitive member is not necessarily sufficient. For example, it is understood that JP 2016-90956 A presents coping with such a situation to some extent. In the technique of JP 2016-90956 A, as shown in FIG. 6 and the like, the number of rotations of the developing device is managed. Thus, in a situation where the developing device is old, the developing bias is adjusted.

However, as a means for solving the problem concerning the lifetime management of the photosensitive member, the technique of JP 2016-90956 A has been still insufficient. The technique of JP 2016-90956 A merely attempts to maintain the image quality by adjusting the developing bias in a situation where it is considered that the deterioration of the developing device is progressing. For this reason, the technique has not been necessarily sufficient for lifetime management of the photosensitive member.

### SUMMARY

The present invention has been made to solve the above-described problems of the conventional techniques. An object of the present invention is to provide an image forming apparatus in which at least a photosensitive member is configured as a replaceable unit, and in which lifetime management of the photosensitive unit is configured to be appropriately performed so as to prevent the degradation of image quality. Another object of the present invention is to provide a system for managing replacement of a photosensitive unit in such an image forming apparatus by a server, and a program for controlling the image forming apparatus.

To achieve at least one of the abovementioned objects, according to an aspect of the present invention, an image forming apparatus reflecting one aspect of the present invention comprises: a rotatable photosensitive member included in a photosensitive unit that is attachable and detachable; an exposing device that forms a latent image on a surface of the photosensitive member; a developing device that forms a toner image by providing toner onto the latent image by using two-component developer; an image stabilization control part that performs optimization of a parameter value of image formation while image formation is not performed; and a replacement determiner that makes determination of replacement of the photosensitive unit on a basis of an optimized value that is the parameter value optimized by the image stabilization control part, wherein the replacement determiner determines that the photosensitive unit should be replaced in a case where the optimized value corresponds to a photosensitive member replacement event that has been determined in advance.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a section view of an image forming apparatus according to embodiments showing a schematic configuration thereof;

FIG. 2 is a section view of an image forming portion in the image forming apparatus according to the embodiments showing a configuration thereof;

FIG. 3 is a block diagram showing a part of a control system of the image forming apparatus according to the embodiments;

FIG. 4 is a plan view of a test pattern formed by attachment amount adjustment control;

FIG. 5 is a graph showing a relationship between a developing bias and an attachment amount in attachment amount adjustment control;

FIG. 6 is a graph showing a relationship between an optimized value of a developing bias determined in attachment amount adjustment control and a rotation time of a photosensitive member;

FIG. 7 is a flowchart showing the contents of a lifetime determination program in a first embodiment;

FIG. 8 is a flowchart showing the contents of a lifetime determination program in a second embodiment;

FIG. 9 is a table showing an example of the transition of a development bias Vdc0 (optimized value) in a plurality of photosensitive units for one developing unit; and

FIG. 10 is a block diagram showing a configuration of a lifetime management system of a photosensitive unit according to a third embodiment.

### DETAILED DESCRIPTION OF EMBODIMENTS

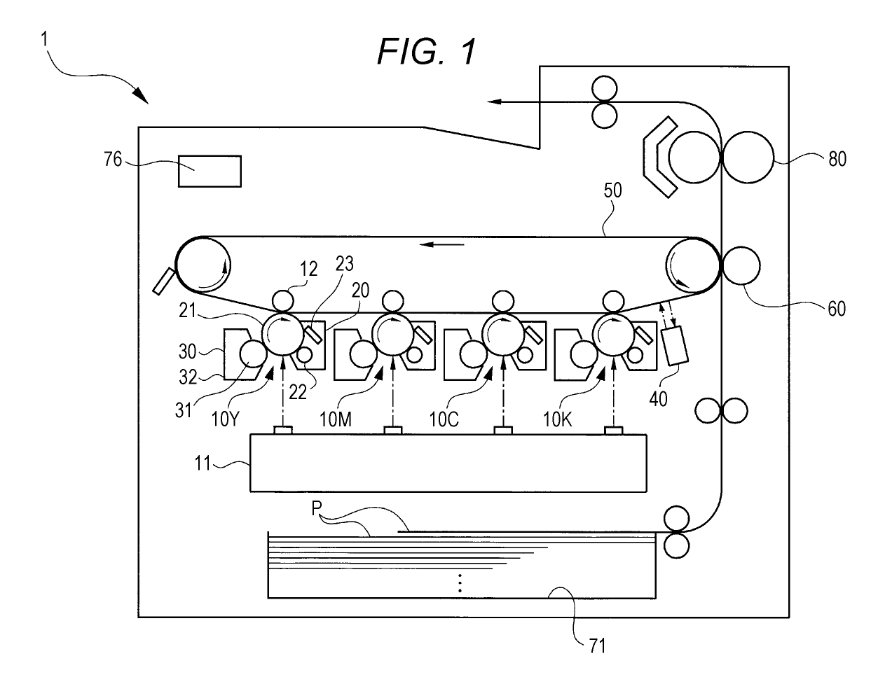

Hereinafter, one or more embodiments of the present invention will be described in detail with reference to the drawings. However, the scope of the invention is not limited to the disclosed embodiments. In the present embodiment, the present invention is applied to an image forming apparatus 1 shown in FIG. 1. The image forming apparatus 1 in FIG. 1 includes an intermediate transfer belt 50, image forming portions 10 (10Y, 10M, 10C, and 10K) of respective four colors (Y, M, C, and K), and a sheet feeding cassette 71. As a result, an image is formed on a printing sheet P by using toner.

More specifically, each of the image forming portions 10 includes a photosensitive member 21 and a developing device 30. The image forming apparatus 1 further includes an exposing device 11, a transfer roller 60, a fixing device 80, and a toner image sensor 40. The exposing device draws a latent image on each photosensitive member 21. The transfer roller 60 transfers a toner image from an intermediate transfer belt 50 onto the printing sheet P. The fixing device 80 fixes the toner image on the printing sheet P. The toner image sensor 40 detects the toner image on the intermediate transfer belt 50. The image forming apparatus 1 also includes a control portion 76. The control portion 76 includes control programs and control data for executing various operations of the image forming apparatus 1. The control programs include a lifetime determination program to be described later. In addition, for the lifetime determination program, the rotation time of the photosensitive member 21 and the number of printed sheets in image formation are counted up.

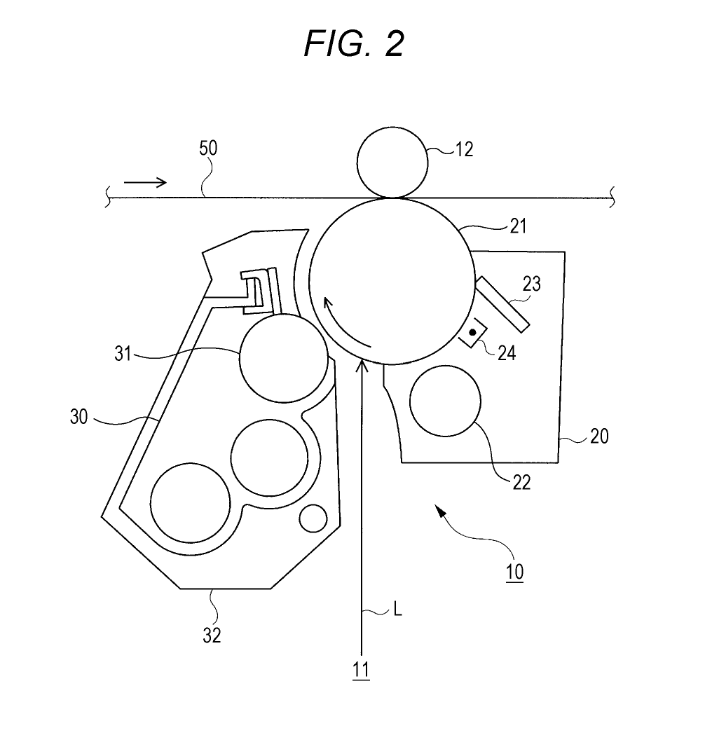

The image forming portion 10 will be further described with reference to the section view of FIG. 2. As shown in FIG. 2, the developing device 30 of the image forming portion 10 includes a developing roller 31. The developing device 30 in the present embodiment accommodates so-called two-component type developer including toner and developer. The developing device 30 is configured to form a layer of developer on the surface of the developing roller 31 and apply toner to the latent image of the photosensitive member 21 from this layer. The developing device 30 is also included in a developing unit 32 that is a unit attachable to and detachable from the image forming apparatus 1.

As further shown in FIG. 2, a cleaner 23, an eraser 24, and a charger 22 are provided around the photosensitive member 21. The photosensitive member 21 and these integrally constitute a photosensitive unit 20 that is a unit attachable to and detachable from the image forming apparatus 1. The attachment and detachment of the photosensitive unit 20 and the attachment and detachment of the developing unit 32 can be performed independently of each other. In addition, the replacement history of the photosensitive unit 20 and the developing unit 32 to new ones is configured to be recorded in the control portion 76. To be noted, the developing device 30 and the photosensitive unit 20 shown in FIG. 1 are drawn in a little more simplified manner than in FIG. 2.

In addition, the components are arranged such that drawing light L from the exposing device 11 irradiates the photosensitive member 21 through a gap between the photosensitive unit 20 and the developing unit 32. Further, a transfer roller 12 is provided on the back side of the intermediate transfer belt 50 as viewed from the photosensitive member 21. As a result, in the image forming apparatus 1, a latent image is drawn with the drawing light L at a portion of the surface of the photosensitive member 21 charged by a charger 22, and a toner image is formed on the latent image by the developing device 30. Toner images formed in such a manner are superimposed on the intermediate transfer belt 50, and are then transferred onto the printing sheet P.

In the image forming apparatus 1 of the present embodiment, image stabilization control is performed in addition to a normal image forming operation. The image stabilization control is control for adjusting various process conditions in order to optimize the image quality of a toner image formed in a normal image forming operation, and is performed at a time not during image formation. The image stabilization control is performed immediately after turning on the power or at every predetermined number of printed sheets. Image stabilization control is also performed even when environmental conditions change. Attachment amount adjustment control is included in the image stabilization control. The attachment amount adjustment control is control to adjust the developing bias of the developing device 30 in order to optimize the attachment amount of toner of a toner image to be formed.

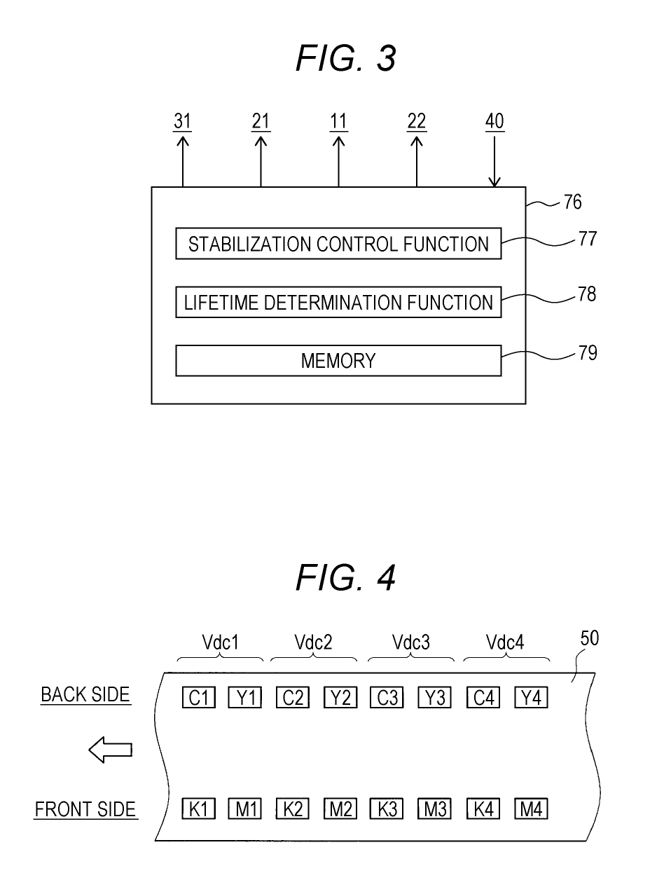

FIG. 3 shows a configuration of a control system of the image forming apparatus 1 of the present embodiment. This control system is constituted mainly by the control portion 76. The control portion 76 operates the developing bias of the developing roller 31, the rotation of the photosensitive member 21, the light emitting operation of the exposing device 11, the charging bias of the charger 22, and the like. In addition, read data provided to the control portion 76 from the toner image sensor 40. The control portion 76 has a stabilization control function 77 for performing image stabilization control and a lifetime determination function 78 executed by the lifetime determination program. Since the developing unit 32 is more expensive than the photosensitive unit 20, replacement of the developing unit 32 is suppressed to the minimum necessary in the present embodiment. The control portion 76 also includes a memory 79 for storing various data.

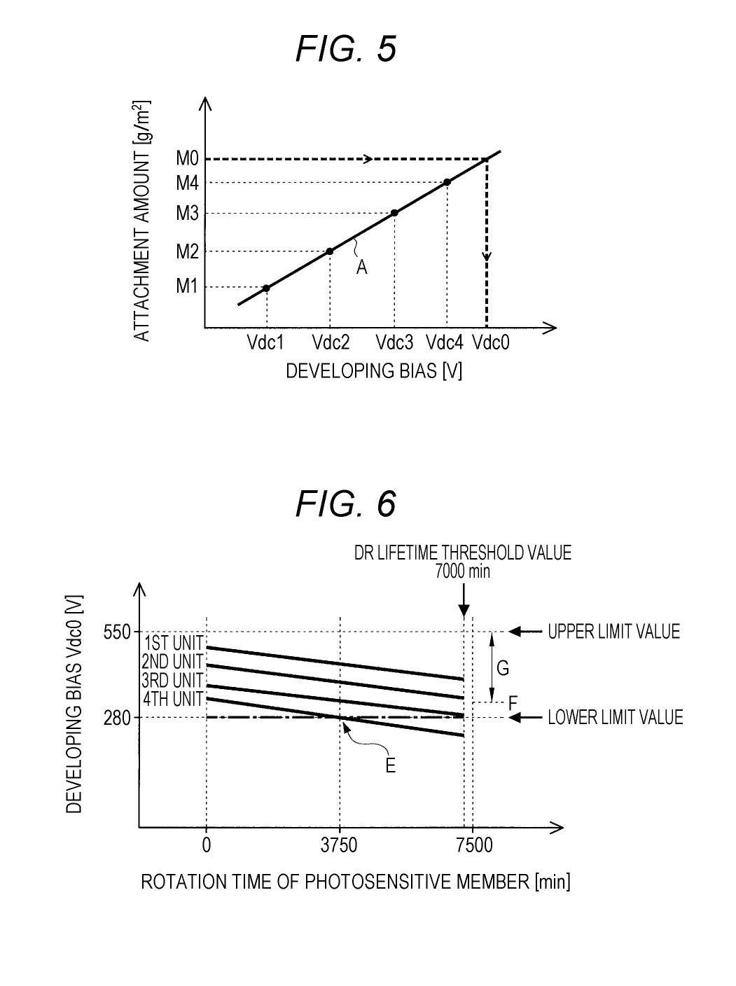

The contents of the attachment amount adjustment control will be described with reference to FIGS. 4 and 5. In the attachment amount adjustment control, as shown in FIG. 4, test patterns of respective colors are formed on the intermediate transfer belt 50 by plural levels of developing bias. Here, an example is shown in which four levels of development bias of Vdc1 to Vdc4 are used. The density (attachment amount toner) of these test patterns is read by the toner image sensor 40. The attachment amounts of toner thus read are plotted against the developing bias as shown in FIG. 5. An approximate straight line A is drawn in accordance with the plotted attachment amounts. Then, by using the approximate straight line A, a developing bias Vdc0 for obtaining a target attachment amount MO is determined. The developing bias Vdc0 thus determined is used for subsequent image formation. An example of M color is shown in FIG. 5, and the same is done for other colors.

The developing bias Vdc0 thus determined is an optimized value of the developing bias that is one of parameter values of image formation. In addition, the developing bias Vdc0 has a correlation with the density of an image to be formed. That is, when the developing bias Vdc0 is low, the density of the image to be formed also becomes low. Therefore, as shown in FIG. 6, the lower limit value of the developing bias Vdc0 is preset. The upper limit value is also preset.

From FIG. 6, the following can be further understood. Firstly, as the cumulative rotation time of the photosensitive member 21 of the photosensitive unit 20 increases, the developing bias Vdc0 decreases. Secondly, as the number of times of replacement of the photosensitive unit 20 increases with respect to that of the developing unit 32, the developing bias Vdc0 decreases. That is, in the example of FIG. 6, a life threshold value of the photosensitive member 21 is set to 7000 minutes in advance in terms of the rotation time. Here, in the first to third photosensitive unit 20, the cumulative rotation time reaches the life threshold value before the developing bias Vdc0 falls below the lower limit value. However, in the fourth photosensitive unit 20, the developing bias Vdc0 falls below the lower limit value (arrow E) before the cumulative rotation time reaches the life threshold value. That is, in the fourth photosensitive unit 20, the image density is expected to be insufficient before the cumulative rotation time reaches the life threshold value.

Therefore, in the image forming apparatus 1 of the present embodiment, the lifetime determination program of the photosensitive unit 20 is executed by using the developing bias Vdc0. This is because the developing bias Vdc0 determined as described above includes information about the remaining life of the photosensitive unit 20. By executing this lifetime determination program, replacement of the photosensitive unit 20 with a new one is promoted to the user as necessary. When the replacement is actually performed, the history thereof is stored in the memory 79 of the control portion 76. The lifetime determination program is executed for each color.

### First Embodiment

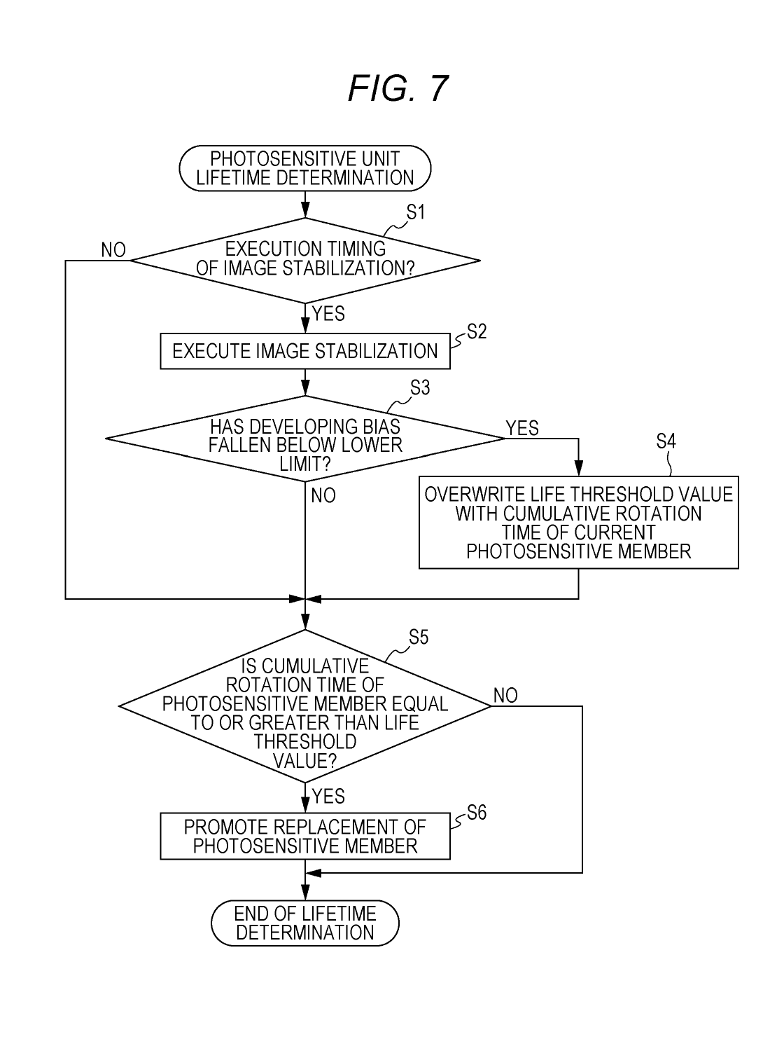

FIG. 7 shows the contents of the lifetime determination program in a first embodiment. This program is executed as needed during the operation of the image forming apparatus 1. For example, the program is necessarily executed immediately after turning on the power and immediately after performing printing. In the flow of FIG. 7, first, it is determined whether or not the current timing is the execution timing of the image stabilization control described above (S1). In the case where the current timing is the execution timing (S1: Yes), the image stabilization control is executed (S2). The attachment amount adjustment control described above is executed as a part of this image stabilization control. As a result, the developing bias Vdc0 is determined for each color. The determined developing bias Vdc0 is stored in the memory 79 of the control portion 76 together with the history thereof. Then, it is determined whether or not the determined developing bias Vdc0 has fallen below the lower limit value thereof (S3).

In the case where the developing bias Vdc0 has fallen below the lower limit (S3: Yes), a value set as the life threshold value of the photosensitive member 21 is overwritten with the current cumulative rotation time of the photosensitive member 21 (S4). Then, the process proceeds to S5. In the case where the developing bias Vdc0 does not fall below the lower limit (S3: No), the process proceeds to S5 without overwriting the life threshold value. In addition, in the case where the current timing is not the execution timing of the image stabilization control in S1 (S1: No), the process proceeds to S5 without performing the processing of S2 to S4.

Then, it is determined whether or not the cumulative rotation time of the current photosensitive member 21 is equal to or greater than the life threshold value (S5). In the case where the cumulative rotation time is equal to or greater than the life threshold value (S5: Yes), an operation (displaying a screen, outputting a voice message, etc.) promoting the replacement of the photosensitive unit 20 is performed (S6). Thus, the flow of FIG. 7 is finished. In the case where the cumulative rotation time is not equal to or greater than the life threshold value (S5: No), the flow of FIG. 7 is finished without performing the operation of S6.

The flow in FIG. 7 is applied to FIG. 6 as follows. First, the life threshold value of the photosensitive member 21 is preset to 7000 minutes. For the first to third photosensitive units 20, the determination of (S3: Yes) is not made and the determination of (S5: Yes) is made. When the photosensitive unit 20 is replaced, in the new photosensitive unit 20 after the replacement, the developing bias Vdc0 transitions through values slightly lower than in the last photosensitive unit 20.

For the fourth photosensitive unit 20, the determination of (S3: Yes) is made prior to the determination of (S5: Yes) (arrow E in FIG. 6). Therefore, the determination in S5 is made after the life threshold value is overwritten with the current value in S4. Therefore, even in the case where the cumulative rotation time of the photosensitive member 21 does not reach 7000 minutes, it is determined that the end of life of the photosensitive unit 20 has come (S5: Yes). This prevents image formation at a density lower than the planned density. To be noted, in the case where the determination of (S3: Yes) is made, the process may immediately proceed to S6 to prompt replacement without overwriting the life threshold value.

That is, in the present embodiment, the developing bias Vdc0 (optimized value) deviating from a predetermined allowable range thereof (280 to 550 V in the example of FIG. 6) is a photosensitive member replacement event for determining that the photosensitive unit 20 should be replaced. In addition to this, it is determined that the photosensitive unit 20 should be replaced also in the case where the cumulative rotation time of the photosensitive member 21 has reached a predetermined life threshold value. To be noted, although a case where the developing bias Vdc0 falls below the lower limit of the allowable range has been shown in the above example, conversely, the developing bias Vdc0 exceeding the upper limit of the allowable range also corresponds to a photosensitive member replacement event.

To be noted, as obvious from FIG. 6, there is a tendency that the developing bias Vdc0 decreases as the number of times of replacement of the photosensitive unit 20 increases. This is because deterioration of the developing unit 32 (deterioration of the charging performance of the developer) progresses because the developing unit 32 is not necessarily replaced when the photosensitive unit 20 is replaced. Therefore, if the number of times of replacement of the photosensitive unit 20 increases, the photosensitive unit 20 to be newly attached is forced to be thrown away without fulfilling the original lifetime thereof (7000 minutes in the above example).

Since this also serves as a factor of waste, in the present embodiment, a special allowable range G can be set for the value of the initial developing bias Vdc0 after the replacement of the photosensitive unit 20. In the case of FIG. 6, this range is narrower than the previously described allowable range of 280 to 550 V. That is, a lower limit value F allowed for the initial developing bias Vdc0 is higher than the lower limit value (280 V in FIG. 6) allowed for the developing bias Vdc0 after using the photosensitive unit 20 for a certain period.

In the case where the initial developing bias Vdc0 after the replacement of the photosensitive unit 20 is lower than the lower limit value F, the replacement of the developing unit 32 is promoted instead of promoting replacement of the photosensitive unit 20 again. This is because it is understood that the deterioration of the developing unit 32 has already progressed considerably. When the developing unit 32 is replaced, the position of the graph in FIG. 6 for the current photosensitive unit 20 is shifted greatly upward. This is because the deteriorated state of the developing unit 32 is eliminated Thereby, the image density can be maintained without greatly wasting the original lifetime of the photosensitive unit 20.

### Second Embodiment

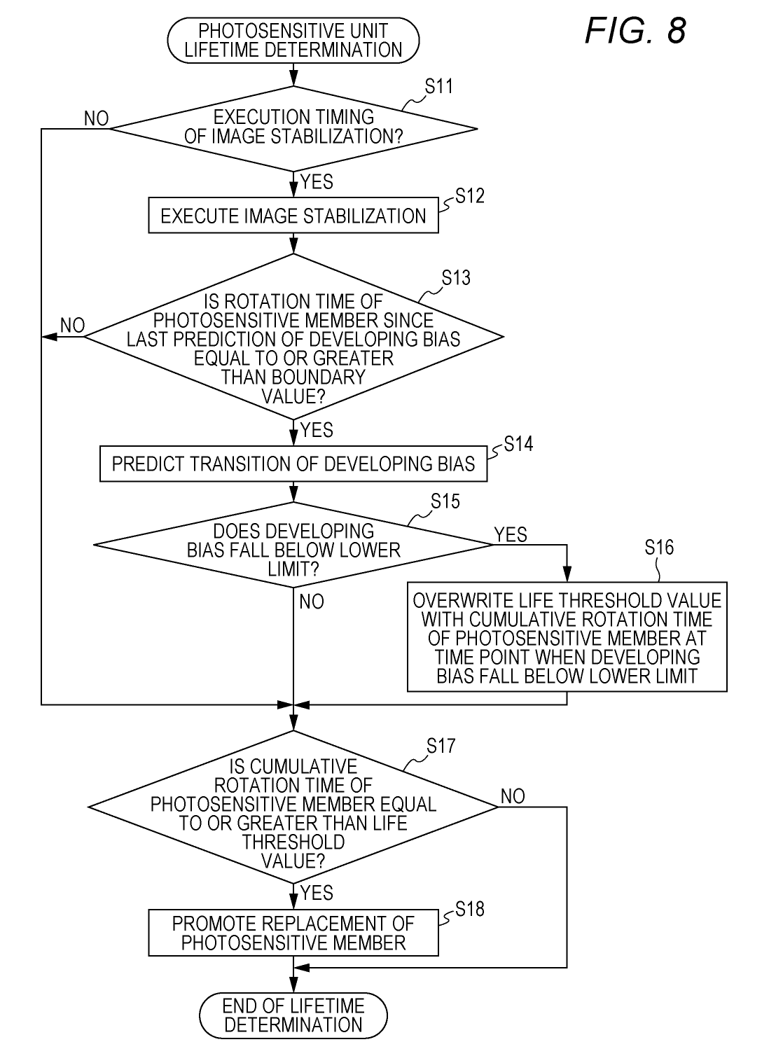

In the second embodiment, future transition of the developing bias Vdc0 is predicted. FIG. 8 shows the contents of the lifetime determination program in the second embodiment. A prediction step (S14) is included in the flow of FIG. 8. This program is the same as that of the first embodiment (FIG. 7) in that the program is executed as needed during the operation of the image forming apparatus 1. Also in the flow of FIG. 8, first, it is determined whether or not the current timing is the execution timing of the image stabilization control described above (S11). In the case where the current timing is the execution timing (S11: Yes), the image stabilization control is executed (S12). The developing bias Vdc0 thus determined is stored in the memory 79 of the control portion 76 together with the history thereof.

Here, it is determined whether or not the rotation time of the photosensitive member 21 from the previous execution of the prediction step of S14 to the present is equal to or greater than a predetermined boundary value (S13). The boundary value is smaller than the life threshold value. The boundary value is set to, for example, about 1000 minutes such that the boundary value is reached multiple times until the cumulative rotation time of the photosensitive member 21 reaches the life threshold value from zero. Alternatively, instead of setting the boundary value as an interval from the execution of the previous prediction step, a plurality of boundary values may be set in advance for the cumulative rotation time of the photosensitive member 21. In this case, the intervals between the boundary values may be set to be close to the aforementioned value.

In the case where the rotation time is equal to or greater than the boundary value (S13: Yes), the prediction step is executed (S14). In this step, the future transition which the developing bias Vdc0 will go through in the case where the photosensitive unit 20 that is currently used is further continued to be used is predicted. This prediction is performed on the basis of the past history of the developing bias Vdc0 accumulated in the memory 79 and the developing bias Vdc0 newly determined in S12 of this time.

For example, it is assumed that the currently used photosensitive unit 20 is the second photosensitive unit 20 for the currently used developing unit 32. In this case, the history of the developing bias Vdc0 in the past includes a graph of the “first unit” in FIG. 6. Now, it is assumed that the developing bias Vdc0 newly determined in S12 of this time is determined immediately after the replacement with the current photosensitive unit 20. Then, the position of the left end (rotation time: zero) of the graph of the “second unit” is known. To this, the inclination of the development bias Vdc0 with respect to the photosensitive member rotation time is applied in the graph of the “first unit”. In this way, the graph that the developing bias Vdc0 of the current photosensitive unit 20 will draw in the future can be predicted. This is prediction of the future transition of the developing bias Vdc0.

In addition, it is assumed that the developing bias Vdc0 newly determined in S12 of this time is determined for the third or newer photosensitive unit 20 for the currently used developing unit 32. Then, the inclination of the graph of the “second unit” can be known from the history of the developing bias Vdc0 in the past. In this case, the inclination of the graph of the “second unit” can be used instead of the inclination of the graph of the “first unit”. A value somehow based on both of the inclinations can be also used.

Now, it is assumed that the currently used photosensitive unit 20 is the first photosensitive unit 20 for the currently used developing unit 32. In this case, no history of the photosensitive unit 20 in the past is included in the history of the developing bias Vdc0 in the past for the current developing unit 32. In this case, an inclination obtained from the history of the developing bias Vdc0 for the developing unit 32 in the past is used as the inclination. Alternatively, in the case where a designed initial value of inclination is provided for the apparatus, the designed initial value can be also used.

After predicting the future transition of the developing bias Vdc0 in this manner, it is subsequently determined whether or not the developing bias Vdc0 will fall below the lower limit (S15). That is, whether or not the developing bias Vdc0 will fall below the lower limit before the rotation time of the photosensitive member 21 reaches the life threshold value is determined on the basis of the predicted transition. For example, it is assumed that the predicted transition is the transition of the graph of the “second unit” in FIG. 6. In this case, the determination can be made as No. This is because the developing bias Vdc0 does not fall below the lower limit even when the rotation time reaches the life threshold value. In addition, it is assumed that the predicted transition is the transition of the graph of the “fourth unit” in FIG. 6. In this case, the determination can be made as Yes. This is because the developing bias Vdc0 falls below the lower limit (arrow E) before the rotation time reaches the life threshold value.

In the case where it is determined that the developing bias Vdc0 will fall below the lower limit (S15: Yes), the value set as the life threshold value of the photosensitive member 21 is overwritten with the rotation time of the photosensitive member 21 calculated as corresponding to the time point at which the developing bias Vdc0 is predicted to fall below the lower limit (S16). The time point at which the developing bias Vdc0 is predicted to fall below the lower limit can be calculated from the inclination described above, the value of the latest developing bias Vdc0, and the lower limit value of the allowable range of the developing bias Vdc0. Then, the process proceeds to S17.

In the case where the developing bias Vdc0 will not fall below the lower limit value (S15: No), the process proceeds to S17 without overwriting the life threshold value. In addition, in the case where the current timing is not the execution timing of the image stabilization control in S11 (S11: No), the process proceeds to S17 without performing the processing of S12 to S16. In addition, in the case where the rotation time of the photosensitive member 21 is not equal to or greater than the boundary value in S13 (S13: No), the process proceeds to S17 without performing the processing of S14 to S16.

Then, it is determined whether or not the cumulative rotation time of the current photosensitive member 21 is equal to or greater than the life threshold value (S17). In the case where the cumulative rotation time is equal to or greater than the life threshold value (S17: Yes), an operation promoting the replacement of the photosensitive unit 20 is performed (S18). Thus, the flow of FIG. 8 is finished. In the case where the cumulative rotation time is not equal to or greater than the life threshold value (S17: No), the flow of FIG. 8 is finished without performing the operation of S18.

The flow in FIG. 8 is applied to FIG. 6 as follows. It is assumed that the initial setting value of the life threshold value of the photosensitive member 21 is 7000 minutes. For the first to third photosensitive units 20 for the first developing unit 32, the determination of (S15: Yes) is not made and the determination of (S17: Yes) is made. That is, the life threshold value of the photosensitive member 21 remains at the initial setting value at this time.

Then, for the fourth photosensitive unit 20, determination of (S15: Yes) is also made when the first determination of (S13: Yes) is made (immediately after replacement of the photosensitive unit 20). As a result, the life threshold value of the photosensitive member 21 is overwritten with the value of the rotation time (4375 minutes) at the position indicated by the arrow E in FIG. 6. Thereafter, when the cumulative rotation time of the photosensitive member 21 reaches the new overwritten life threshold value, it is determined that the end of life of the photosensitive unit 20 has come (S17: Yes) even if the cumulative rotation time has not reached 7000 minutes.

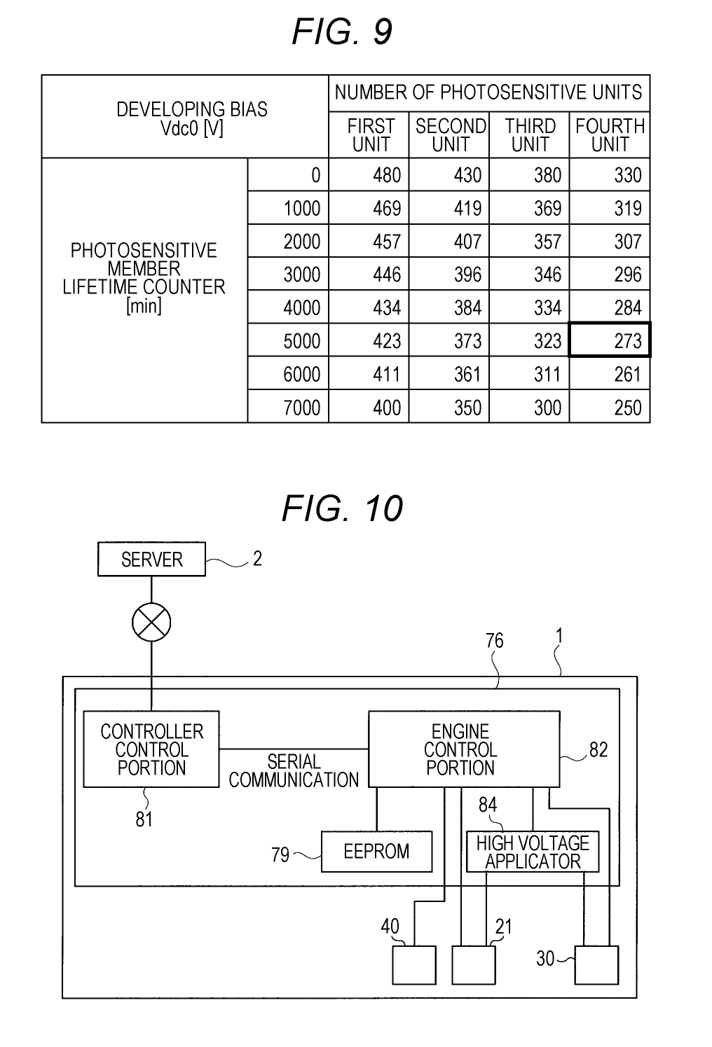

An example of the transition of the value of the developing bias Vdc0 for these four photosensitive units 20 is shown in FIG. 9. In FIG. 9, the part corresponding to the first to third units are actual values recorded as the history. The part corresponding to the fourth unit represents predicted transition. At the point of 5000 minutes of the part corresponding to the fourth unit, the value falls below the lower limit value of 280 V for the first time. For this reason, the life threshold value is updated for the fourth unit. In FIG. 9, the rotation time of the photosensitive member 21 is shown at 1000-minute intervals. However, if the rotation time is shown at smaller intervals, the developing bias Vdc0 falls below 280 V for the first time around the midpoint between 4000 and 5000 minutes.

To be noted, also in the second embodiment, it is possible to replace the developing unit 32 as described in the last part of the first embodiment. Meanwhile, even in the case where the life threshold value is overwritten in S16 of FIG. 8 as described above, the life threshold value is set back to the initial setting value (7000 minutes in the above example) in the case where the developing unit 32 is replaced thereafter.

### Third Embodiment

In a third embodiment, in a system in which the image forming apparatus 1 is connected to a server, the lifetime management of the photosensitive unit 20 is performed by the server. The configuration of the system in the third embodiment is shown in the block diagram of FIG. 10. In the system of FIG. 10, the image forming apparatus 1 and the server 2 are connected via a public line. The control portion 76 of the image forming apparatus 1 is divided into a controller control portion 81 and an engine control portion 82. The controller control portion 81 and the engine control portion 82 are interconnected by serial communication. The controller control portion 81 is connected to the server 2 via the public line.

Among the components shown in FIG. 1, the photosensitive member 21, the developing device 30, and the toner image sensor 40 are connected to the engine control portion 82. In addition, EEPROM is used as the memory 79 of the control portion 76 in FIG. 10, and is connected to the engine control portion 82. Further, a high voltage applicator 84 in the control portion 76 for applying a high voltage such as a developing bias is also connected to the engine control portion 82. To be noted, in FIG. 10, among the components shown in FIG. 1, components not necessary for explanation of a remote management system by the server 2 are omitted.

In such a system of FIG. 10, the lifetime determination of the photosensitive unit 20 is performed in accordance with the procedure of the flowchart of FIG. 8 described in the second embodiment. However, whereas all procedures are performed by the control portion 76 in the second embodiment, some procedures are performed by the server 2 in the third embodiment. Specifically, the part of S14 to S16 in FIG. 8 are performed by the server 2. Other procedures are performed by the control portion 76 of the image forming apparatus 1.

Therefore, the engine control portion 82 collects information necessary for the lifetime determination. The necessary information includes the newly acquired developing bias Vdc0 (optimized value) and the history thereof, and information of the rotation time of the photosensitive member 21. Further, a configuration in which individual identification information (so-called serial number) of the currently used photosensitive unit 20 is acquired may be also employed.

The information collected by the engine control portions 82 is transmitted to the controller control portion 81 by serial communication, and further to the server 2 via the public line. In the information transmitted from the controller control portion 81 to the server 2, the individual identification information of the image forming apparatus 1 itself may be included instead of the individual identification information of the photosensitive unit 20. Then, the server 2 performs the prediction of the transition of S14, the determination of S15, and the calculation of the predicted timing of S16 when the determination is Yes. When the determination is Yes, the predicted timing that has been calculated is returned to the image forming apparatus 1. The returned information is transmitted to the engine control portion 82 in a reverse course to the above course, and the life threshold value is updated. The image forming apparatus 1 as the reply destination is specified by individual identification information of the photosensitive unit 20 or individual identification information of the image forming apparatus 1.

To be noted, the determination of S17 may be also performed by the server 2 in addition to S14 to S16. In this case, the life threshold value is also managed on the server 2 side, and updating is also performed in the server 2 as necessary. Then, the reply content from the server 2 to the image forming apparatus 1 becomes an execution instruction of the replacement promoting operation of S18. Storing of the history of the developing bias Vdc0 described above can be also performed on the server 2 side instead of by the image forming apparatus 1. In addition, the lifetime determination of the photosensitive unit 20 described above can be also performed by the procedure of FIG. 7 of the first embodiment instead of FIG. 8. In this case, the part of S3 and S4 in FIG. 7, or the part of S3 to S5 are performed on the server 2 side.

The merit of performing such remote management is as follows. First, the necessity of replacing the photosensitive unit 20 in the image forming apparatus 1 can be grasped in advance on the server 2 side. Therefore, there is an advantage that a new photosensitive unit 20 can be shipped without waiting for an order from the user. In addition, it is of course advantageous that the processing load in the control portion 76 of the image forming apparatus 1 can be reduced. To be noted, the lifetime management may be performed by the server 2 not only for the photosensitive unit 20 but also for the developing unit 32. Of course, one server 2 may centrally manage many image forming apparatuses 1.

[The description of the third embodiment ends here.]

As described in detail above, according to the present embodiment, the lifetime determination of the photosensitive unit 20 is performed not only on the basis of the cumulative rotation time of the photosensitive member 21 but also on the basis of the occurrence of a photosensitive member replacement event (falling below the lower limit value and the like) predetermined for the developing bias Vdc0 (optimized value). Therefore, the lifetime determination of the photosensitive unit 20 can be performed under a condition in which the image quality is degraded due to the deterioration of the developing device 30 even when the cumulative rotation time of the photosensitive member 21 is not so long. Thereby, the image forming apparatus 1 in which deterioration of the image quality is less likely to occur is realized. This is particularly important in the case where the developing device 30 of the image forming apparatus 1 is of a so-called trickle type in which both of the toner and the developer are supplied from a supply container and degraded developer is discharged.

In addition, a lifetime management system of an image forming apparatus capable of providing a new photosensitive unit 20 to a user in advance can be realized by performing the part of lifetime determination by a server separated from the image forming apparatus 1. Furthermore, a program for an image forming apparatus suitable for controlling the image forming apparatus 1 used in the lifetime management system is realized.

Note that the present embodiments are merely examples and do not limit the present invention at all. Accordingly, various improvements and modifications can be naturally made within the scope not departing from the gist of the present invention. For example, the target image forming apparatus 1 may be a monochromatic type, or may have both a scanner function and an external transmission/reception function of a print job. Also, the photosensitive member replacement event may be predetermined in another way than the deviation from the allowable range of the developing bias Vdc0. For example, the value of the new development bias Vdc0 being deviated from the tendency of the value of the development bias Vdc0 so far, and the like can be determined as the photosensitive member replacement event.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a rotatable photosensitive member included in a photosensitive unit that is attachable and detachable;
an exposing device that forms a latent image on a surface of the photosensitive member;
a developing device that forms a toner image by providing toner onto the latent image by using two-component developer;
an image stabilization control part that performs optimization of a parameter value of image formation while image formation is not performed; and
a replacement determiner that makes determination of replacement of the photosensitive unit on a basis of an optimized value that is the parameter value optimized by the image stabilization control part,
wherein the replacement determiner determines that the photosensitive unit should be replaced in a case where the optimized value corresponds to a photosensitive member replacement event that has been determined in advance.

2. The image forming apparatus according to claim 1,
wherein the photosensitive member replacement event in the replacement determiner includes the optimized value being out of a predetermined allowable range.

3. The image forming apparatus according to claim 2,
wherein the developing device is included in a removable developing unit, and the replacement determiner makes determination of replacement of the developing unit on a basis of the optimized value, and
the replacement determiner determines that the developing unit should be replaced in a case where the optimized value after replacement of the photosensitive unit is out of a predetermined second allowable range narrower than the allowable range.

4. The image forming apparatus according to claim 1, further comprising
a life counter that counts a number of rotations of the photosensitive member,
wherein the replacement determiner determines that the photosensitive unit should be replaced also in a case where a count value of the life counter has reached a predetermined life threshold value.

5. The image forming apparatus according to claim 3, further comprising
a life counter that counts a number of rotations of the photosensitive member,
wherein the replacement determiner determines that the photosensitive unit should be replaced also in a case where a count value of the life counter has reached a predetermined life threshold value.

6. The image forming apparatus according to claim 1, further comprising:
a charger that charges the surface of the photosensitive member before the formation of the latent image by the exposing device; and
a high voltage applicator that applies a developing bias to the developing device and applies a charging bias to the charger,
wherein the developing bias and the charging bias are included in the parameter value for the image stabilization control part, and the replacement determiner makes determination of replacement of the photosensitive unit by setting the developing bias after the optimization as the optimized value.

7. The image forming apparatus according to claim 5, further comprising:
a charger that charges the surface of the photosensitive member before the formation of the latent image by the exposing device; and
a high voltage applicator that applies a developing bias to the developing device and applies a charging bias to the charger,
wherein the developing bias and the charging bias are included in the parameter value for the image stabilization control part, and the replacement determiner makes determination of replacement of the photosensitive unit by setting the developing bias after the optimization as the optimized value.

8. The image forming apparatus according to claim 5, further comprising:
an optimized value history storage that stores the optimized value that is newest at a time point when the count value of the life counter has reached any one of a plurality of predetermined boundary values that are smaller than the life threshold value;
a transition predictor that determines, from what is stored in the optimized value history storage, transition of the optimized value expected in future in a case where use of the photosensitive unit that is currently used is continued;
a prediction determiner that determines, on a basis of a result of determination by the transition predictor, whether or not the photosensitive member replacement event will occur before the count value of the life counter reaches the life threshold value;
a timing calculator that, in a case where it has been determined that the photosensitive member replacement event will occur by the prediction determiner, calculates a new life threshold value that is a count value of the life counter at a timing at which it is predicted that the photosensitive member replacement event will occur; and
a threshold value updater that updates the life threshold value by the calculated new life threshold value.

9. The image forming apparatus according to claim 7, further comprising:
an optimized value history storage that stores the optimized value that is newest at a time point when the count value of the life counter has reached any one of a plurality of predetermined boundary values that are smaller than the life threshold value;
a transition predictor that determines, from what is stored in the optimized value history storage, transition of the optimized value expected in future in a case where use of the photosensitive unit that is currently used is continued;
a prediction determiner that determines, on a basis of a result of determination by the transition predictor, whether or not the photosensitive member replacement event will occur before the count value of the life counter reaches the life threshold value;
a timing calculator that, in a case where it has been determined that the photosensitive member replacement event will occur by the prediction determiner, calculates a new life threshold value that is a count value of the life counter at a timing at which it is predicted that the photosensitive member replacement event will occur; and
a threshold value updater that updates the life threshold value by the calculated new life threshold value.

10. The image forming apparatus according to claim 8,
wherein an initial setting value of the life threshold value is preset in the threshold value updater, and, in a case where the developing unit is replaced, the threshold value updater sets the life threshold value back to the initial setting value.

11. The image forming apparatus according to claim 9,
wherein an initial setting value of the life threshold value is preset in the threshold value updater, and, in a case where the developing unit is replaced, the threshold value updater sets the life threshold value back to the initial setting value.

12. A replacement management system for an image forming apparatus, the replacement management system comprising:
an image forming apparatus; and
a server capable of communicating with the image forming apparatus,
wherein the image forming apparatus includes:
a rotatable photosensitive member included in a photosensitive unit that is attachable and detachable;
an exposing device that forms a latent image on a surface of the photosensitive member;
a developing device that forms a toner image by providing toner onto the latent image by using two-component developer; and
an image stabilization control part that performs optimization of a parameter value of image formation while image formation is not performed,
the server includes a replacement determiner that makes determination of replacement of the photosensitive unit on a basis of an optimized value that is the parameter value optimized by the image stabilization control part, and
the replacement determiner determines that the photosensitive unit should be replaced in a case where the optimized value corresponds to a photosensitive member replacement event that has been determined in advance.

13. The replacement management system for an image forming apparatus according to claim 12,
wherein information transmitted from the image forming apparatus to the server includes individual identification information of the image forming apparatus or the photosensitive unit in addition to the optimized value.

14. The replacement management system for an image forming apparatus according to claim 13,
wherein the image forming apparatus includes a life counter that counts a number of rotations of the photosensitive member,
the information transmitted from the image forming apparatus to the server includes a count value of the life counter, and
the replacement determiner determines that the photosensitive unit should be replaced also in a case where the count value has reached a predetermined life threshold value.

15. A non-transitory recording medium storing a computer readable program for controlling an image forming apparatus including a rotatable photosensitive member included in a photosensitive unit that is attachable and detachable, an exposing device that forms a latent image on a surface of the photosensitive member, and a developing device that forms a toner image by providing toner onto the latent image by using two-component developer, the program causing the image forming apparatus to perform:
optimizing a parameter value of image formation while image formation is not performed;
transmitting an optimized value to a sever, the optimized value being the parameter value optimized in the image stabilization control; and
promoting replacement of the photosensitive unit when a result of determination made by the server on a basis of the optimized value, the result indicating that the photosensitive unit should be replaced.

16. The non-transitory recording medium storing a computer readable program for controlling an image forming apparatus according to claim 15, the program further causing the image forming apparatus to perform:
acquiring individual identification information of the image forming apparatus or the photosensitive unit; and
in the transmitting, transmitting the individual identification information of the image forming apparatus or the photosensitive unit to the server.
